(19) United States
(12) Patent Application Publication
(10) Pub. No.: US 2014/0098444 A1
(43) Pub. Date: Apr. 10, 2014

(54) STALL DELAY ATTACHMENT

(71) Applicants: Robert M. Lumpkins, Ashbury Park, NJ (US); Deborah Lumpkins, Bowie, MD (US)

(72) Inventors: Robert M. Lumpkins, Ashbury Park, NJ (US); Deborah Lumpkins, Bowie, MD (US)

(21) Appl. No.: 13/492,837

(22) Filed: Oct. 4, 2012

(51) Int. Cl. H02H 1/00

(52) U.S. Cl. CPC H02H 1/00
USPC 361/1

(57) ABSTRACT

The Stall Delay Attachment is a copper terminal strip that is designed to increase the life of any battery, voltage regulator or starter by acting as a surge protector or a heat sink that dissipates heat only for electrical current and would be attached and fused into a battery cable that leads to the battery on one end and attached and fused to an electrical wire leading to the voltage regulator or starter on the opposite end of the Stall Delay unit requiring no direct connection of the Stall Delay unit to the battery, voltage regulator or starter of any car, boat, motorcycle, riding lawn mower, tractor, truck or RV.

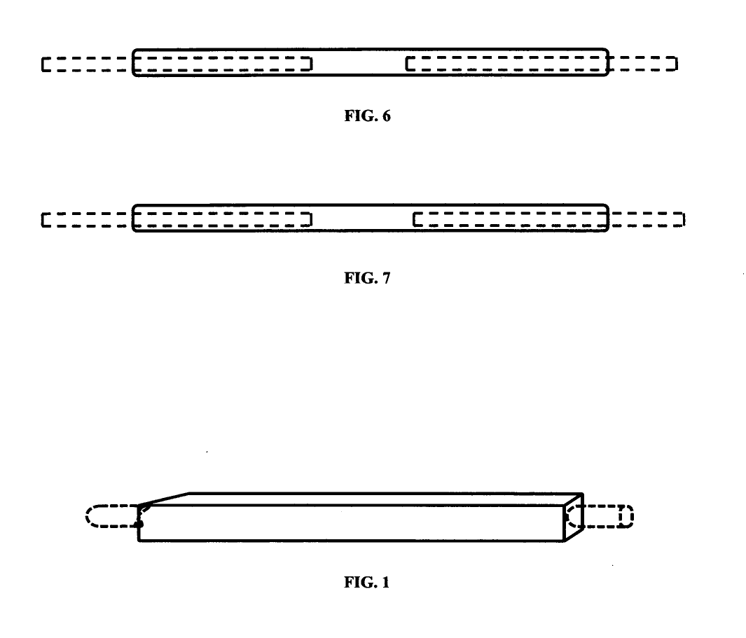

FIG. 1 is a perspective view of a rubber coated copper plate for preventing an alternator regulator or generator from breaking down showing my new design:

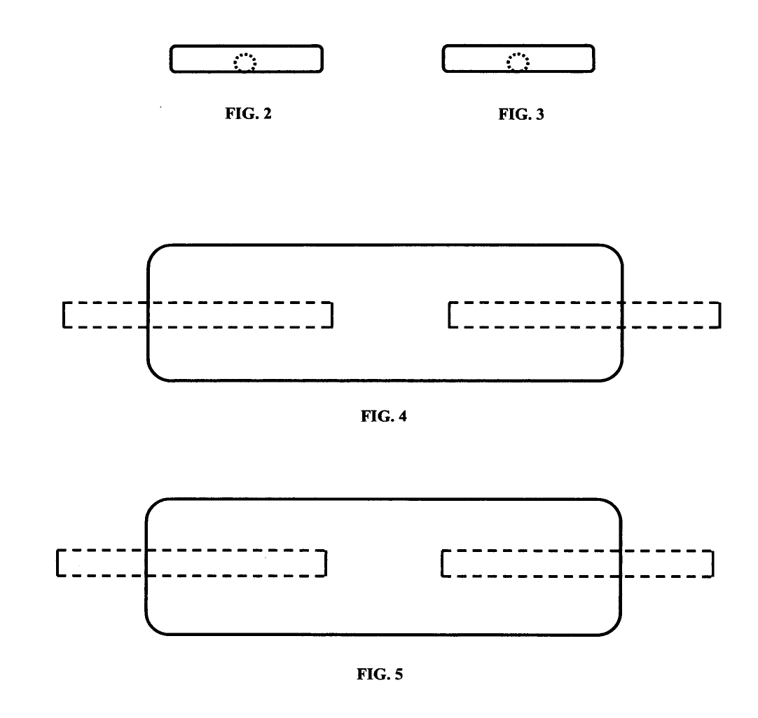

FIG. 2 is a front elevational view thereof;

FIG. 3 is a rear elevational view thereof;

FIG. 4 is a top plan view thereof;

FIG. 5 is a bottom plan view thereof;

FIG. 6 is a left side elevational view thereof;

FIG. 7 is a right side elevational view thereof;

The broken lines shown represent infused internal/external copper wire and is part of the claimed design.

1. The ornament design for a rubber coated copper plate for preventing an alternator, regulator or generator from breaking down. As shown and described.
